(19) United States
(12) Patent Application Publication
(10) Pub. No.: US 2004/0000736 A1
(43) Pub. Date: Jan. 1, 2004

(54) Process for the production of polyurethane molded parts and their use

(76) Inventor: Werner Rasshofer, Koln (DE)

Correspondence Address: BAYER POLYMERS LLC, 100 BAYER ROAD, PITTSBURGH, PA, 15205, US

(21) Appl. No.: 10/601,457

(22) Filed: Jun. 23, 2003

(30) Foreign Application Priority Data
Jun. 26, 2002 (DE) 10228473.3

(51) Int. Cl. B29C 65/00

(52) U.S. Cl. 264/41

(57) ABSTRACT

The present invention relates to a process for the manufacture of polyurethane molded parts, blocks and cylinders from production residues and/or from so-called post-consumer parts based on polyurethane by the so-called flake composite technique, and to their use.

### BACKGROUND OF THE INVENTION

The present invention relates to a process for the manufacture of polyurethane molded parts, blocks and cylinders from production residues and/or from so-called post-consumer parts based on polyurethane by the so-called flake composite technique, and to their use.

The utilisation (recycling) of polyurethane flexible foam scraps by the so-called flake composite technology is known. In this process polyurethane flexible foam scraps are comminuted, a 1- or 2-component-adhesive (generally based on isocyanate, though, alternatively thermoplastic materials or phenol resins may also be used as adhesives) is added, and the mixture is hardened with steam. In the case where blocks or cylinders are produced, these are processed further into molded parts, lengths or sheets. The production of the blocks/cylinders or of the molded parts may be carried out under the co-use of further materials such as, for example fillers, reinforcing substances, e.g. fibers, or additives, e.g. flameproofing agents. Molded parts instead of blocks/cylinders may also be produced directly. Instead of flexible foam, it is also possible to use PU-elastomer foam scraps in small amounts in this, technology.

The blocks, cylinders or molded parts produced in this way are employed in various industrial sectors, such as the furniture, building, construction, recreational, sports and environmental technology sectors, e.g. for comfort applications, such as for example upholstered furniture, carpet backings, cushions, applications in automobile interiors (e.g. headrests and seat inlays), mattresses, as well as packagings and sound insulation, and for sound protection.

The flake composite technology has been known for a long time and is described for example in EP-A 1 097 798, WO 2001/00718, U.S. Pat. No. 6,136,870, JP-A 10 193 356, JP-A 09 302 219, WO 95/29951, WO 95/514055, EP-A 976 518 and DE-A 29 810 967 as well as G. Oertel, Polyurethane, Kunststoffhandbuch, 3^{rd} Edition, 1993, p. 210; W. RaBhofer, Recycling von Polyurethan-Kunststoffen, Hüthig-Verlag 1994, p. 139 and W. RaBhofer and E. Weigand, Recycling of Automotive Polyurethanes, Technomic Publ., 2001, p. 65. Products based on this technology are obtainable e.g. from the company Metzeler, Memmingen (Germany).

Neither the literature relating to nor the practical experience gained in the field of flake composite production provide any suggestions of the possibility of using rigid foam in flake composite production. On the contrary, those skilled in the art held a preconceived opinion that effective results could not be obtained with rigid foams using the flake composite technology employed solely for highly flexible foams.

The object of the present invention was to provide a possible way of reusing (recycling) production raw materials from polyurethane rigid foam production and so-called post-consumer parts based on polyurethane rigid foam.

Such a method of recycling is important since environmental protection laws, such as the European Used Car Directive and the Electric and Electronic Waste Directive, increasingly require the recycling of plastic parts.

This object was achieved by a special process for working up the aforementioned scraps (residues) and post-consumer parts by means of the flake composite technique.

### SUMMARY OF THE INVENTION

The invention provides a process for the production of blocks, cylinders or molded parts. This process comprises:

(1) adding and uniformly distributing

b) a liquid binder containing reactive NCO groups and based on a mixture and/or reaction product of:

i) aromatic and/or aliphatic polyisocyanates and

ii) polyols, to

a) production residues from polyurethane rigid foam production and/or post-consumer arts based on polyurethane rigid foam which are optionally comminuted,

(2) adding the mixture from (1) to a tool,

(3) introducing steam, optionally under pressure, into the tool for the production of the molded part, block or cylinder,

(4) hardening the product, and

(5) removing the resultant molded part, block or cylinder from the tool,

wherein a) the polyurethane rigid foam comprises an open-cell foam with a density of 5 to 50 kg/m³ (measured according to DIN 53 420), a compressive strength of 0.05 to 0.2 MPa (measured according to DIN 53 421) and an open cell content of more than 50% (determined according to DIN ISO 4590-86).

As polyurethane rigid foam material there is preferably employed as a) in the process of the present invention a material that is used for the production of vehicle PU roof liners. Baynat® from Bayer AG, Leverkusen, is an example of such a preferably used foam material.

In the production and processing of open-cell rigid foams residues occur in amounts of up to 25 wt. % of the employed raw materials. In this connection these raw materials/parts may contain other production accompanying substances, such as for example paper, without interfering in the production process when they are used in step (1). Such production accompanying substances may then also be a constituent of the molded parts, blocks and cylinders produced according to the invention.

Apart from residues from the production and the further processing of open-cell rigid foam, there may also be employed scraps from the production of finished products based on open-cell rigid foams, such as for example stamping waste from roof liners or also spent roof liners, such as occur for example in the disposal of old vehicles, as starting material in the production of the blocks, cylinders and molded parts according to the invention.

Component b) consists of one- or two-component binders (adhesives). These are either mixtures or reaction products of isocyanates (i) and isocyanate-reactive components (ii), e.g. of 100 parts of (i) and from 100 to 1000 parts of (ii).

Suitable isocyanates (i) are compounds having a molecular weight of higher than 137, and preferably from 168 to 290, and containing only (cyclo)aliphatically bound isocyanate groups, such as for example 1,6-diisocyanatohexane, 1,12-diisocyanatododecane, 1,3-diisocyanato-cyclobutane, 1,3- and 1,4-diisocyanato-cyclohexane, and any desired mixtures of these isomers, 1-isocyanato-3,3,5-trimethyl-5-isocyanato-methyl-cyclohexane (IPDI), 2,4- and/or, 4,4′-diisocyanatodicyclo-hexylmethane or any desired mixtures of such simple (cyclo)aliphatic polyisocyanates. Isocyanates which are also suitable are urethane-, allophanate-, isocyanurate, urea-, biuret- and/or uretdione-modified polyisocyanates based on the (cyclo)aliphatic diisocyanates mentioned as examples or based on mixtures thereof. Mixtures of unmodified diisocyanates with the abovementioned modified polyisocyanates can also be used as component (i).

Additional suitable isocyanates are any desired aromatic polyisocyanates having an NCO content of 10-50 wt. %.

Component (ii) consists of compounds containing isocyanate-reactive groups of a molecular weight in the range from 1,800 to 12,000, preferably from 3,000 to 7,000, or of mixtures of such compounds and has, for the purposes of the isocyanate addition reaction, an average functionality of higher than 2.5, preferably from 2.6 to 3.0, and particularly preferably from 2.8 to 3.0. Compounds which are particularly suitable for use as component (ii) are polyether polyols or mixtures of polyether polyols which conform to the present specifications and are of the kind disclosed in column 6, line 65, to column 7, line 47, of DE-A 2 622 951, such polyether polyols also being preferred according to the invention whose hydroxyl groups consist of at least 50%, and preferably at least 80%, of primary hydroxyl groups. The hydroxyl-containing polyesters, polythioethers, polyacetals, polycarbonates or polyester amides disclosed as examples in DE-A 2 622 951 are also, in principle, suitable for use as component (ii) according to the invention, as long as they conform to the abovementioned specifications, although they are less preferred than polyether polyols.

The production according to the invention of blocks, cylinders or molded parts is preferably carried out by a process in which production scraps from the production of polyurethane rigid foams and/or post consumer parts based on polyurethane rigid foam are first of all comminuted. This can take place using commercially available machines such as cutting mills or shredders. A so-called flake material is thereby obtained. Then a liquid binder containing reactive NCO groups and based on a mixture and/or reaction product of i) aromatic and/or aliphatic polyisocyanates (e.g. monomeric or polymeric MDI, TDI) and ii) polyols (e.g. with molecular weights of in the region of 6000, functionalities of about 3 and 15% terminal polyethylene oxide) is added to the flakes and uniformly dispersed. The binder is absorbed by the flakes but does not cure under normal conditions. Then the flakes thus treated are introduced into a mold and the required density, e.g. 80 or 100 kg/m³, is adjusted by the application of pressure and diminishing the volume. The surface of the flake material introduced is possibly equilibrated. By introducing steam, optionally under pressure, into the mold, the material is heated and curing is obtained by reaction with the water. After curing, the molding, block or cylinder is removed from the mold.

Instead of curing with water vapour, curing can also take place by leaving the products to stand for several hours or several days at room temperature (not preferred).

The properties of the molded parts, blocks and cylinders produced according to the invention are characterised by the properties of the rigid foam materials and binders that are used, as well as the amounts and reaction parameters, such as, for example:

a) the average particle size of the rigid foam materials is preferably 1 to 80 mm, especially preferred 15 to 80 mm,

b) the use of a cutting mill screen with circular or rectangular holes having a diameter of for example 25 to 80 mm, if a cutting mill is used for comminution,

c) the particle size distribution, in particular dust fraction,

d) the amount and nature of the binder preferably ranges from 5 to 25 wt. %, based on 100 wt. % of the rigid foam,

e) the mixing time in step (1) of the process preferably ranges from 1 to 60 minutes,

f) degree of filling of the tool and pressure in the tool,

g) the steam temperature, which preferably ranges from 105° to 140° C., and time for which the steam acts, e.g. 10 sec. to 5 min.,

h) the hardening time in the tool, which preferably ranges from 1 to 60 minutes.

The molded parts, blocks and cylinders produced according to the invention and the sheets cut into size or lengths obtained therefrom preferably have densities of 40 to 200 kg/m³ after storage.

The best method for a mainly foam content is preferably carried out using the following parameters:

1. average particle size of the flake material: 3 to 5 cm in diameter

2. binder: a prepolymer of crude MDI and a polyether with a molecular weight of 6000, a functionality of 3 and 15% terminal polyethylene oxide

3. binder: 15 wt. % of binder per 100 parts of the flake material

4. NCO content of the binder: 3%

5. mixing time of the binder with the flake material at a filling quantity of 200 kg: 5 mins.

6. injection time of the steam: 5 mins.

7. temperature of the steam: 130° C.

8. post-curing time (after the injection time of the stream): 0 mins.

The addition of other auxiliary substances and additives, such as for example flame-retarding agents, such as melamine, expanded graphite or aluminium oxide, and reinforcing materials, such as for example glass and jute fibers, is not specifically preferred but may be carried out technically without any problem in the production of the molded parts, blocks and cylinders according to the present invention.

In order to prevent voids in the blocks produced it may be advantageous to use vibration or other oscillation processes in order to obtain as solid a filling of the tools and the pre-compression of the flake material as possible.

The blocks or cylinders may be processed into articles in the from of sheets or lengths. Normally, the sections cut from the blocks are, for example, 6 to 30 mm thick. These sections are then processed further.

These sections are preferably used for the production of finished article laminates, such as for example door interior linings, hat racks, trunk linings and roof liners, in particular in shaping hot compression molding, such as for example in the so-called continuous Tramico process or in discontinuous processes.

In addition, board-shaped sections of the blocks can be treated, by impregnation or soaking with a polyisocyanate or with a polyisocyanate/polyl-mixture and then pressed to form a laminate.

In addition, the use of sections for absorbing energy in the collision areas of vehicles is possible.

The products according to the invention can also be used in the building sector, such as for example for footfall insulation.

The advantage of the molded parts, blocks and cylinders produced according to the invention and of the process employed in their production processes is that production raw materials occuring in particular in batchwise production processes are recovered and can thereby be used again. The molded parts, blocks and cylinders may, in particular, preferably be used again in the automotive sector after suitable processing, thereby meeting the requirements of the used car directive and the expectations of the general public with regard to plastics recycling.

The blocks, cylinders and molded parts produced according to the invention are preferably employed in the production of finished article laminates such as for example door interior linings, hat racks, trunk linings and roof liners.

Despite the use of these production scraps (residues) resulting from the manufacture of rigid foam and post-consumer parts based on polyurethane rigid foam the resultant molded parts, blocks and cylinders have surprisingly good sound-damping properties comparable to those of commercially available rigid foams for roof liners. Due to the reduced open cell content of the resultant molded parts, blocks and cylinders it would have been expected, because of the cell-closing action of the added adhesive, that the damping properties of the molded parts, blocks and cylinders according to the present invention would be significantly worse. In many cases the acoustic properties are even considerably superior to those of virgin foams, particularly in the low-frequency range of below 2000 Hz. They also normally meet, without any additives, the requirements of flame resistance according to FMVSS 302 and the horizontal burning rate of Regulation 95/28/EG.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

### What is claimed is:

1. A process for the production of molded parts, blocks and cylinders, comprising:
(1) adding and uniformly distributing
b) a liquid binder containing reactive NCO groups and based on a mixture and/or reaction product of:
i) aromatic and/or aliphatic polyisocyanates, and
ii) polyols, to
a) production residues from polyurethane rigid foam production and/or post-consumer parts based on polyurethane rigid foam,
(2) adding the mixture from (1) to a tool,
(3) introducing steam, optionally under pressure, into the tool for the production of the molded part, block or cylinder,
(4) hardening the product, and
(5) removing the resultant molded part, block or cylinder from the tool,
wherein a) said polyurethane rigid foam comprises an open-cell foam with a density of 5 to 50 kg/m³ (measured according to DIN 53 420), a compressive strength of 0.05 to 0.2 Mpa (measured according to DIN 53 421) and an open cell content of more than 50% (determined, according to DIN ISO 4590-86).

2. The process of claim 1, wherein (a) said post-consumer parts are communited.

3. The process of claim 1, wherein the average particle size of the rigid foam materials is from 1 to 80 mm.

4. The process of claim 1, wherein b) said liquid binder is present in an amount of from 5 to 25% by weight, based on 100% by weight of the rigid foam a).

5. The process of claim 1, wherein the steam introduced in step (3) is at a temperature of 105 to 140° C.

6. The process of claim 2, wherein (d) hardening of the product occurs for 1 to 60 minutes.

7. The process of claim 1, wherein the resultant molded part, block or cylinder has a density of from 40 to 200 kg/m³.
